(19) United States
(12) Patent Application Publication
(10) Pub. No.: US 2026/0175589 A1
(43) Pub. Date: Jun. 25, 2026

(54) LIQUID CONTAINER AND METHOD OF MANUFACTURING LIQUID CONTAINER

(71) Applicant: SEIKO EPSON CORPORATION, Tokyo (JP)

(72) Inventors: Kiyoteru KATAUKI, Azumino-shi (JP); Hiroki MATSUOKA, Azumino-shi (JP); Kazuyuki HIRATA, Shiojiri-shi (JP)

(73) Assignee: SEIKO EPSON CORPORATION, Tokyo (JP)

(21) Appl. No.: 19/426,293

(22) Filed: Dec. 19, 2025

(30) Foreign Application Priority Data
Dec. 20, 2024 (JP) 2024-224995

(51) Int. Cl. B41J 2/175

(52) U.S. Cl. CPC B41J 2/17523; B41J 2/17513; B41J 2/1754; B41J 2/17553; B41J 2/17559; B41J 2002/17516

(57) ABSTRACT

A liquid container includes an inner bag capable of containing ink, an outer bag covering a periphery of the inner bag and having a light-shielding property against an ultraviolet ray, and a lead-out portion capable of leading out the ink from the inner bag covered with the outer bag.

The present application is based on, and claims priority from JP Application Serial Number 2024-224995, filed December 20, 2024, the disclosure of which is hereby incorporated by reference herein in its entirety.

### BACKGROUND

### 1. Technical Field

The present disclosure relates to a liquid container and a method of manufacturing a liquid container.

### 2. Related Art

JP-A-2014-097620 discloses an ink pack formed by joining films into a form of a bag for sealing an ultraviolet curable ink therein. The films have a multilayer structure including a base layer of resin and a light-shielding layer laminated on the base layer and are joined to each other at end portions of the respective base layers into a form of a bag. It is disclosed that the ink pack has a configuration for preventing entry of ultraviolet rays from an end surface of a joint portion of the end portions.

For example, in this configuration, one of the films is provided with an extended portion as a portion of the light-shielding layer extending from the base layer, and the extended portion is folded back and covers the end surface of the joint portion of the end portions. Alternatively, in this configuration, the respective films are provided with the extended portion as a portion of the light-shielding layer extending from the base layer, and the extended portions are joined to each other. Alternatively, in this configuration, a coating layer of ultraviolet blocking resin covering the end surface of the joint portion at the end portions is formed on the extended portion including the end surface. Alternatively, in this configuration, a tape-like sealing element including a light-shielding layer covers the end surface of the joint portion at the end portions.

However, in order to realize the configuration for preventing entry of ultraviolet rays from the end surface of the joint portion at the end portions of the ink pack of JP-A-2014-097620, the process of manufacturing the ink pack may be complicated.

### SUMMARY

A liquid container includes an inner bag capable of containing a liquid, an outer bag covering a periphery of the inner bag and having a light-shielding property against an ultraviolet ray, and a lead-out portion capable of leading out the liquid from the inner bag covered with the outer bag.

A method of manufacturing a liquid container includes disposing, in a film member through an opening of the film member, an inner bag including a lead-out portion capable of leading out a liquid, the film member having a light-shielding property against an ultraviolet ray and being formed in a sleeve shape, and sealing the opening of the film member to form an outer bag in a state where the lead-out portion is exposed from the film member.

### BRIEF DESCRIPTION OF THE DRAWINGS

FIG. 1 is a perspective view of a printing apparatus according to an embodiment.

FIG. 2 is a schematic configuration diagram of the printing apparatus when viewed from front.

FIG. 3 is a schematic plan view of a liquid supply portion when viewed from above.

FIG. 4 is a schematic perspective view of the liquid supply portion.

FIG. 5 is a schematic exploded perspective view of a liquid container taken out of a case.

FIG. 6 is a perspective view of an inner bag in the liquid container.

FIG. 7 is a perspective view of the liquid container from which an adapter is removed.

FIG. 8 is a perspective view of a film member.

FIG. 9 is a perspective view illustrating a state where an opening at a first end of the film member is sealed.

FIG. 10 is a view illustrating a method of manufacturing the liquid container.

FIG. 11 is a view illustrating the method of manufacturing the liquid container.

FIG. 12 is a view illustrating the method of manufacturing the liquid container.

FIG. 13 is a flowchart illustrating the method of manufacturing the liquid container.

### DESCRIPTION OF EMBODIMENTS

Hereinafter, the present disclosure will be described based on embodiments. In each figure, the same members are denoted by the same reference numerals, and redundant description will be omitted. The terms "same", "identical", "simultaneous", and "similar" as recited in the present specification do not only refer to being completely the same.

For example, in the present specification, when "same", "identical", or "simultaneous" is recited, the term includes being the same in consideration of a measurement error. In addition, for example, in the present specification, when "same", "identical", or "simultaneous" is recited, the term includes being the same in consideration of manufacturing variations of members.

In the present specification, when "same", "identical", or "simultaneous" is recited, the term includes being the same in a range in which a function is not impaired. Therefore, for example, "the dimensions of both are the same" means that the difference in dimension between the two is within ±5%, particularly preferably within ±3%, of one dimension in consideration of a measurement error and manufacturing variations of members.

In each of the drawings, X, Y, and Z represent three spatial axes that are orthogonal to each other. In the present specification, the directions along these axes are referred to as an X-axis direction, a Y-axis direction, and a Z-axis direction. When a direction is specified, a positive direction is denoted by "+", a negative direction is denoted by "-", and by using the positive and negative signs together in the direction notation, the direction in which an arrow points in each drawing will be described as a + direction, and the direction opposite to the arrow will be described as a - direction.

The Z-axis direction indicates a vertical direction, a +Z direction indicates a vertically downward direction, and a -Z direction indicates a vertically upward direction. A plane including the X-axis and the Y-axis is described as an X-Y plane, a plane including the X-axis and the Z-axis is described as an X-Z plane, and a plane including the Y-axis and the Z-axis is described as a Y-Z plane. The X-Y plane is a horizontal plane. Three spatial axes of X, Y, and Z that do not limit the positive direction and the negative direction will be described as the X-axis, the Y-axis, and the Z-axis.

The X-axis direction is a horizontal direction along an installation surface which is a horizontal surface on which a printing apparatus 10 is installed. The Y-axis direction is a horizontal direction along the installation surface on which the printing apparatus 10 is installed. The Z-axis direction is a normal direction with respect to the installation surface on which the printing apparatus 10 is installed and is a height direction of the printing apparatus 10.

In the following description, a -Y direction may be referred to as a "front direction", and a +Y direction may be referred to as a "rear direction". A -X direction may be referred to as a "right direction", and a +X direction may be referred to as a "left direction". The -Z direction may be referred to as an "upward direction", and the +Z direction may be referred to as a "downward direction". For convenience of illustration, the size of each member may be different from the actual size.

### Embodiments

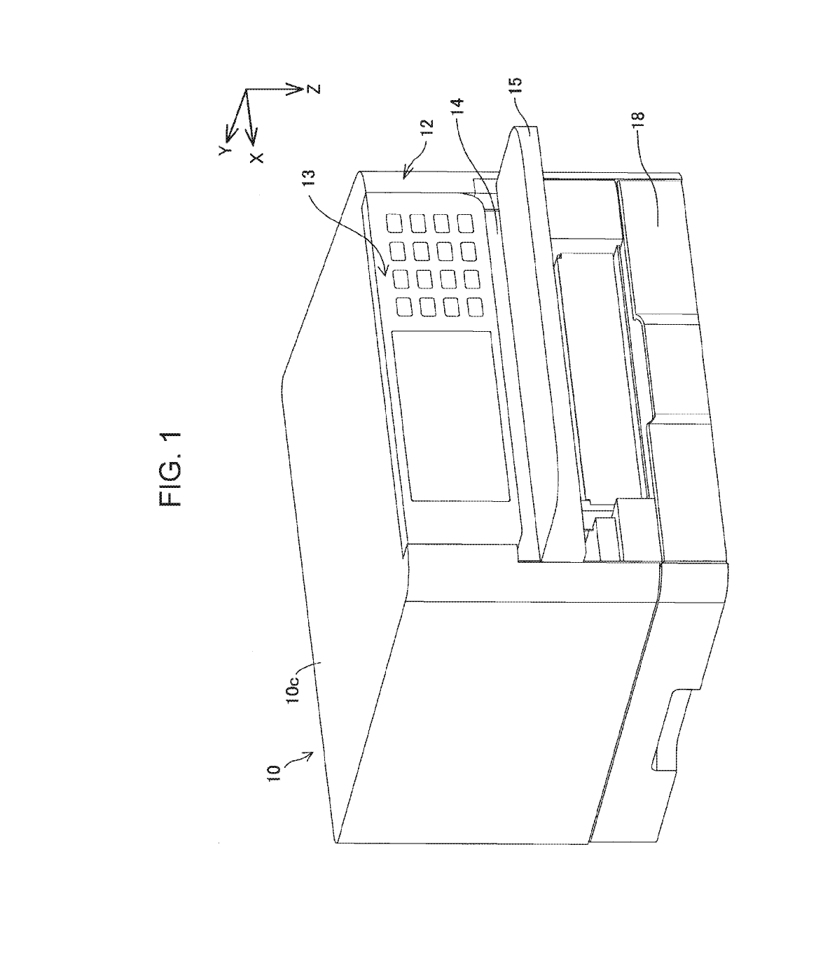

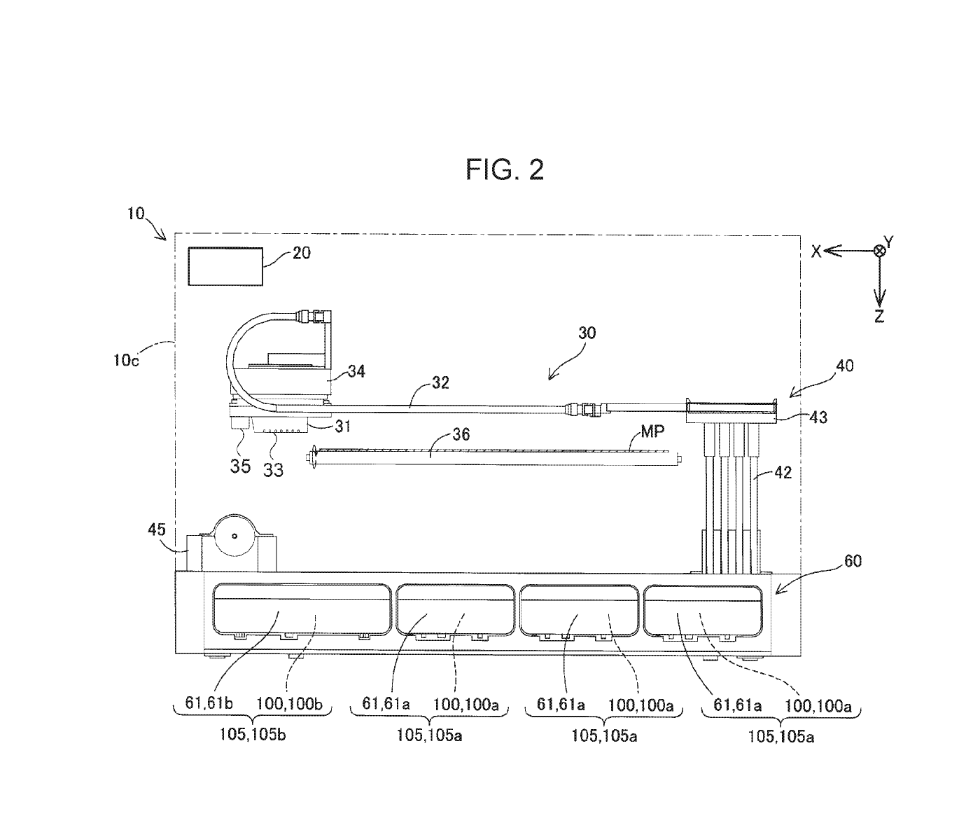

A schematic configuration of the printing apparatus 10 according to an embodiment will be described. As illustrated in FIG. 1, in the present embodiment, the printing apparatus 10 is configured as an ink jet printer and forms an image by ejecting ink onto a medium MP (see FIG. 2).

Ink is an example of a liquid. Examples of the medium MP include printing paper, fabric, and a resin film. In this case, the printing paper, the fabric, and the resin film are examples of the medium MP.

The printing apparatus 10 of the present embodiment includes a housing 10c which is a resin-made hollow box body constituting an exterior of the printing apparatus 10. The housing 10c has a substantially rectangular parallelepiped shape. A front surface portion 12 of the housing 10c is provided with an operation unit 13, a medium discharge port 14, a medium receiving portion 15, and a cover member 18.

The operation unit 13 includes a display portion that displays information for a user and a plurality of operation buttons that receives an operation of the user. The medium discharge port 14 is an outlet of the medium MP fed out from the inside of the printing apparatus 10. The medium discharge port 14 is a slit-shaped opening having a large width in the X-axis direction. The medium receiving portion 15 protrudes in an eaves shape in the -Y direction below the medium discharge port 14 and receives the medium MP discharged from the medium discharge port 14.

The cover member 18 is a plate-shaped member formed of resin and forms a portion of the exterior of the printing apparatus 10. The cover member 18 is detachably attached to the housing 10c. The cover member 18 covers and protects mounting bodies 105 illustrated in FIG. 2 which are accommodated inside the printing apparatus 10.

As illustrated in FIG. 2, the printing apparatus 10 includes a control unit 20, an ejection execution unit 30, a transport roller 36, a liquid supply portion 40, and a case accommodation portion 60.

The case accommodation portion 60 is disposed on an inner side of the cover member 18 illustrated in FIG. 1 and is disposed at the lowermost stage of the printing apparatus 10. Four mounting bodies 105 are accommodated in the case accommodation portion 60. Specifically, the four mounting bodies 105 include three first mounting bodies 105a and one second mounting body 105b.

The first mounting bodies 105a are different in size from the second mounting body 105b. The second mounting body 105b is larger than the first mounting bodies 105a. Each mounting body 105 is constituted by a case 61 and a liquid container 100 accommodated in the case 61.

Similarly to the mounting bodies 105, four cases 61 include three first cases 61a and one second case 61b. Four liquid containers 100 include three first liquid containers 100a and one second liquid container 100b.

Each first mounting body 105a is configured such that the first liquid container 100a is accommodated in the first case 61a. The second mounting body 105b is configured such that the second liquid container 100b is accommodated in the second case 61b.

The second liquid container 100b is different from the first liquid container 100a in that the second liquid container 100b has a wider inner bag 110 to be described later and the amount of ink the second liquid container 100b can contain is larger than that of the first liquid container 100a. For example, the three first liquid containers 100a may contain cyan ink, magenta ink, and yellow ink, respectively, and the second liquid container 100b may contain black ink. The ink of the present embodiment is an ultraviolet curable ink which is cured by being irradiated with ultraviolet rays.

The ejection execution unit 30 includes a liquid ejecting unit 31, a plurality of tubes 32, and a carriage 34. The plurality of tubes 32 is arranged in the Y-axis direction and is connected to the liquid ejecting unit 31. A nozzle 33 that opens downward is provided on a bottom surface of the liquid ejecting unit 31. The liquid ejecting unit 31 ejects ink from the nozzle 33 by, for example, applying pressure to the ink using a piezoelectric element.

The liquid ejecting unit 31 and an ultraviolet irradiation unit 35 are mounted on the carriage 34. The carriage 34 reciprocates along the X-axis. The transport roller 36 is installed in the X-axis direction below the liquid ejecting unit 31. The transport roller 36 transports the medium MP.

The ink is ejected from the liquid ejecting unit 31 which is mounted on the carriage 34 and reciprocates along the X-axis with respect to the medium MP which is transported. In addition, the ink adhering to the medium MP is cured by irradiating the ink adhering to the medium MP with ultraviolet rays from the ultraviolet irradiation unit 35 which is mounted on the carriage 34 and reciprocates along the X-axis. Accordingly, the ink is fixed to the medium MP, and thus image formation on the medium MP is completed.

The liquid supply portion 40 includes four supply pipes 42, a joint 43, and a suction unit 45. Each of the four supply pipes 42 is connected to a corresponding one of the four liquid containers 100. The joint 43 connects each of the four supply pipes 42 to a corresponding one of the plurality of tubes 32.

The ink contained in the liquid containers 100 is supplied to the liquid ejecting unit 31 through the four supply pipes 42, the joint 43, and the plurality of tubes 32. The suction unit 45 generates pressure for sending the ink from the liquid containers 100 to the supply pipes 42.

The control unit 20 controls driving of each unit in the printing apparatus 10. The control unit 20 is configured by a microcomputer including at least a central processing unit and a main storage device. The control unit 20 exhibits various functions by the central processing unit reading various programs into the main storage device and executing the programs.

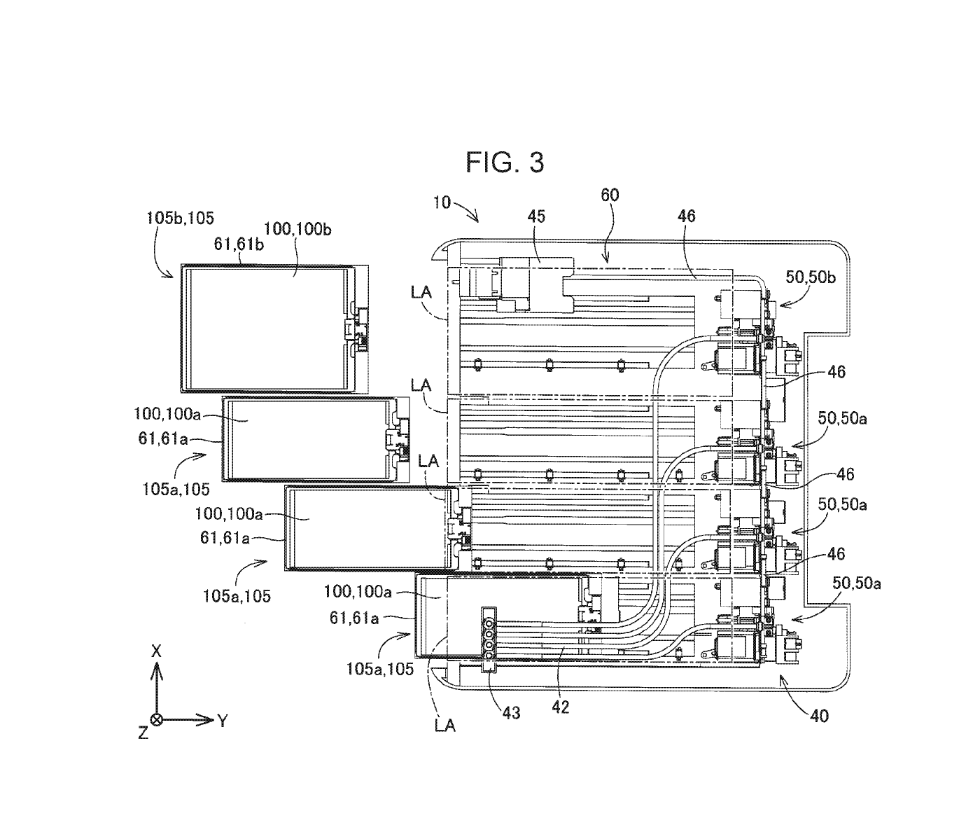

As illustrated in FIG. 3, the mounting bodies 105 are inserted into the case accommodation portion 60 from the outside toward the +Y direction. The four mounting bodies 105 are arranged in the X-axis direction and accommodated in the case accommodation portion 60. In FIG. 3, disposition regions LA where the mounting bodies 105 are disposed in the case accommodation portion 60 are indicated by one-dot chain lines.

The liquid supply portion 40 includes four switching mechanisms 50 and a pressure transmission pipe 46 in addition to the above-described components. The four switching mechanisms 50 are disposed on the +Y direction side of the disposition regions LA. Each of the four switching mechanisms 50 is disposed corresponding to one of the four disposition regions LA.

Specifically, the four switching mechanisms 50 include three first switching mechanisms 50a and one second switching mechanism 50b. Each of the three first switching mechanisms 50a corresponds to one of the three first liquid containers 100a. The second switching mechanism 50b corresponds to the second liquid container 100b.

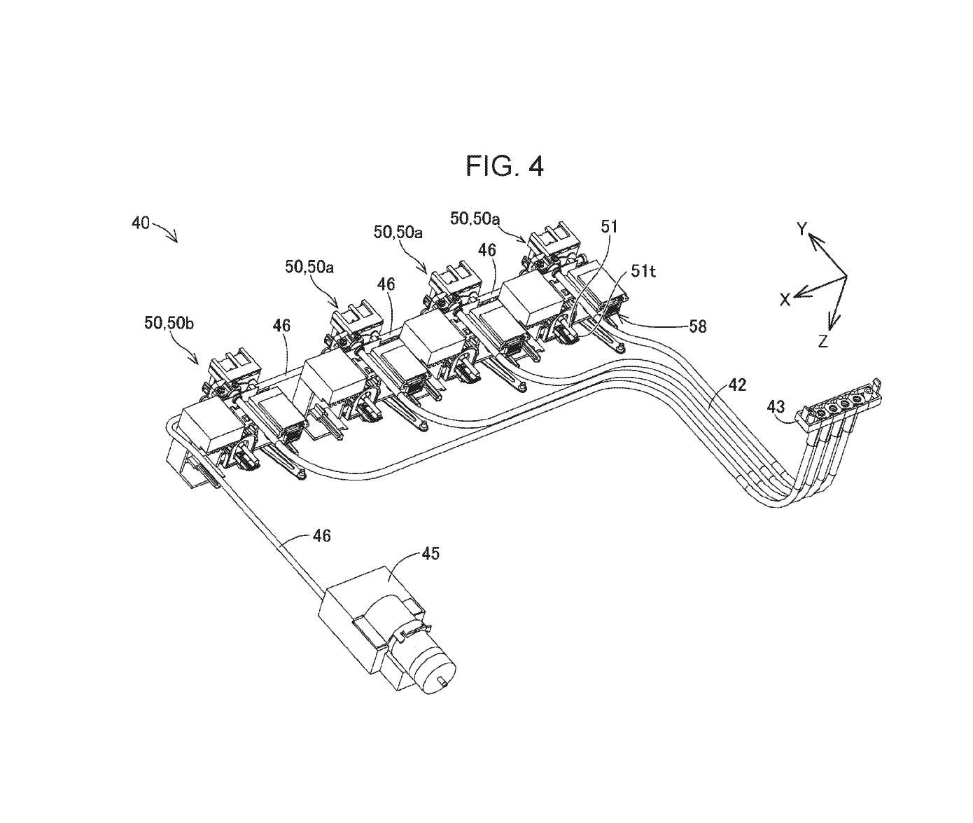

As illustrated in FIG. 4, each switching mechanism 50 has a liquid introduction portion 51 and an apparatus-side terminal 58. The liquid introduction portion 51 is detachably connected to the liquid container 100. The liquid introduction portion 51 has a tubular shape extending linearly in the -Y direction.

The liquid introduction portion 51 is connected to the liquid container 100 by a tip portion 51t thereof being inserted into a liquid supply portion 121 to be described later of the liquid container 100. The ink contained in the liquid container 100 flows through the inside of the liquid introduction portion 51. The pressure transmission pipe 46 transmits the pressure generated by the suction unit 45.

The apparatus-side terminal 58 is formed of a plate-like member having elasticity. The apparatus-side terminal 58 is electrically connected to the control unit 20 illustrated in FIG. 2 via wiring or the like.

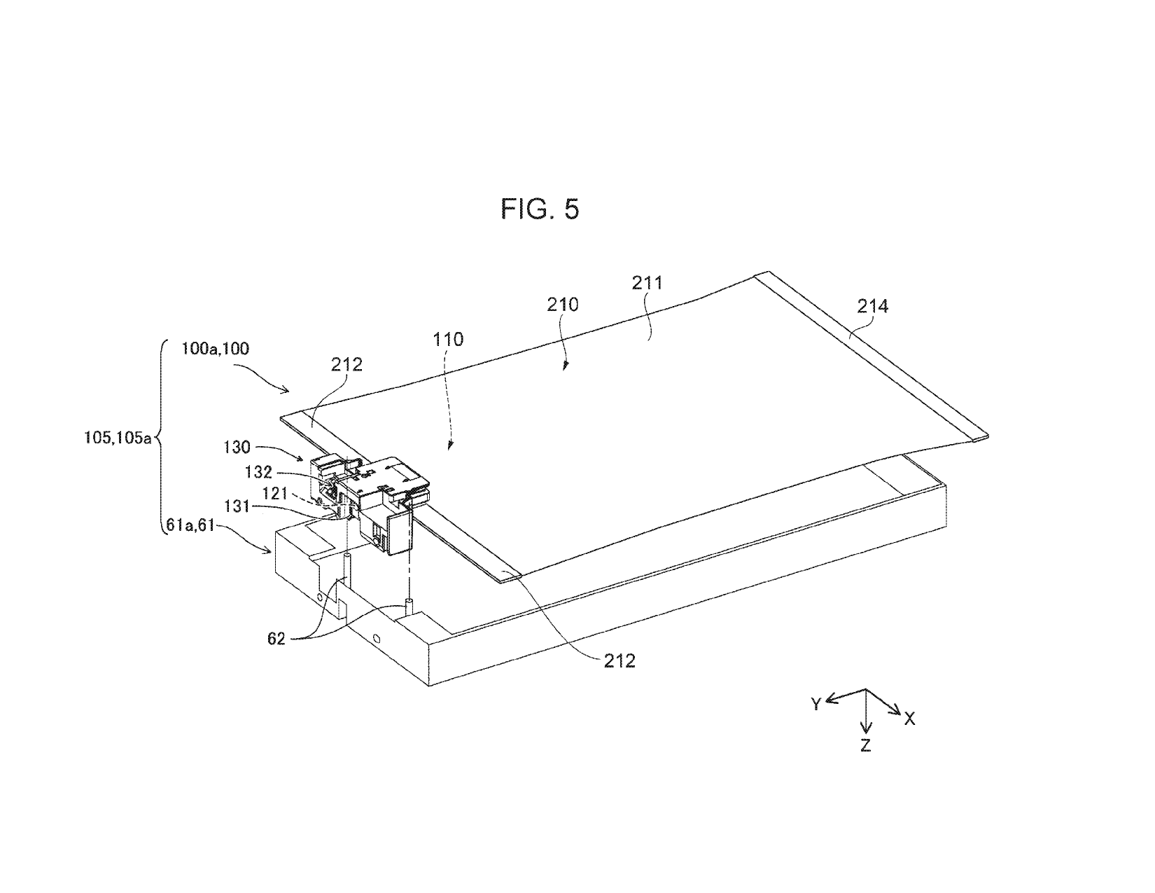

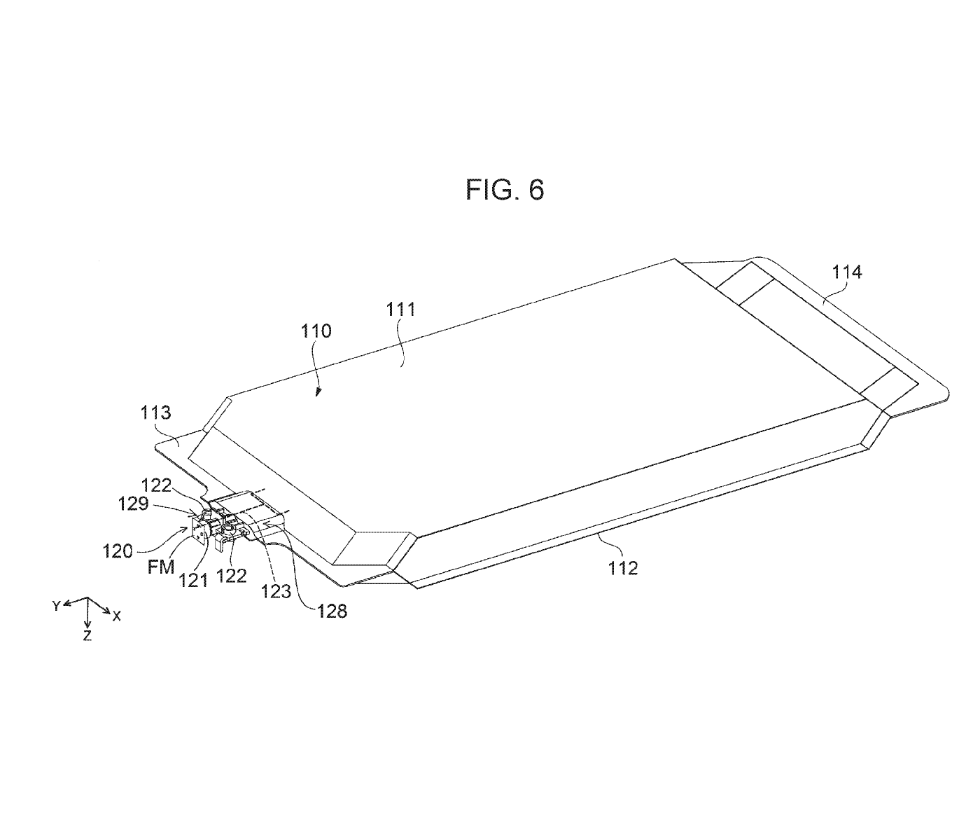

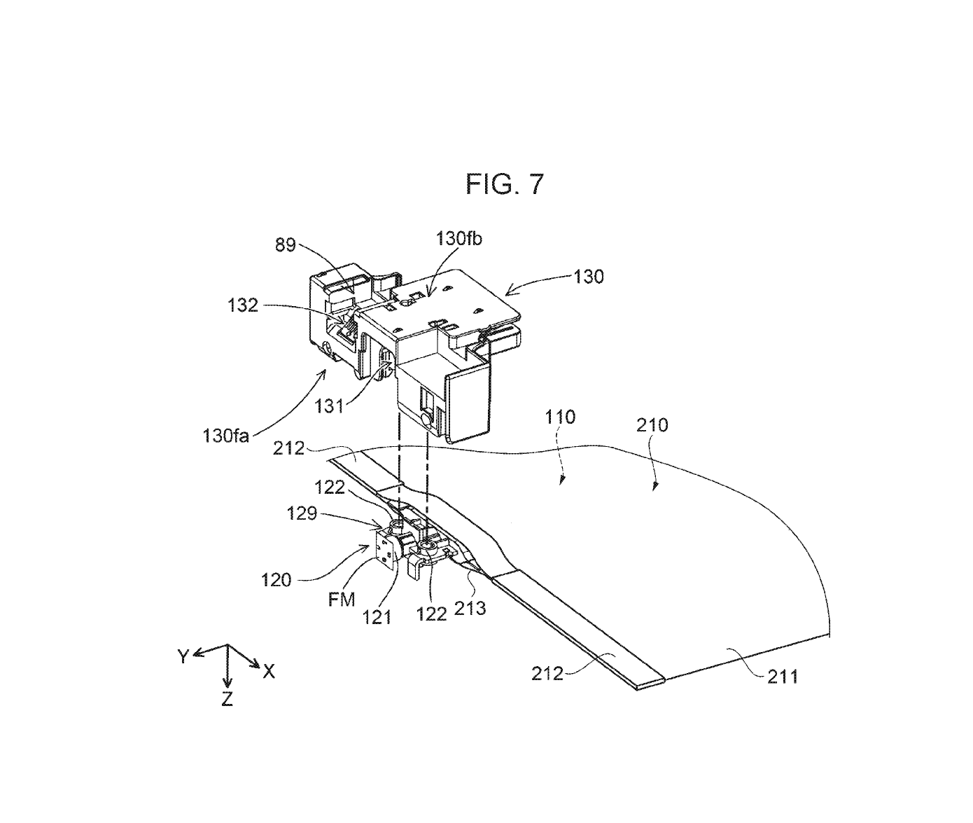

Next, a configuration of the liquid container 100 according to the embodiment will be described. FIG. 5 is a schematic exploded perspective view of the first liquid container 100a taken out from the first case 61a. FIG. 6 is a perspective view of the inner bag 110. FIG. 7 is a schematic exploded perspective view in a state where an adapter 130 is removed from a lead-out portion 120. The second mounting body 105b has a configuration similar to that of the first mounting bodies 105a. Therefore, hereinafter, the first mounting bodies 105a will be representatively described, and the description of the second mounting body 105b will be omitted.

As illustrated in FIG. 5, the case 61 is a tray-shaped container having an open top. The case 61 is made of, for example, a resin member such as polypropylene. The liquid container 100 is detachably accommodated in the case 61 from above.

Two columnar guide portions 62 rising upward from an inner bottom surface of the case 61 are provided at an end portion of the case 61 in the +Y direction. In a case where the liquid container 100 is accommodated in the case 61, the two guide portions 62 guide a guided portion (not illustrated) provided in the adapter 130 to be described later.

The liquid container 100 includes the inner bag 110, an outer bag 210, and the adapter 130. As illustrated in FIG. 6, the inner bag 110 is provided with the lead-out portion 120. The inner bag 110 is a bag body capable of containing ink.

The ink of the present embodiment is an ultraviolet curable ink, but since the liquid container 100 includes the outer bag 210, it is possible to apply specifications similar to those of a bag body for containing a general ink to the inner bag 110.

Here, a general ink is different from the ultraviolet curable ink and is, for example, an ink which is fixed to the medium MP by solidifying the ink adhering to the medium MP by volatilization of water or a solvent which is a solvent of the ink.

The inner bag 110 has flexibility. The inner bag 110 is formed by bonding a plurality of films. The bag-shaped inner bag 110 is formed by overlapping a plurality of films constituting the inner bag 110 and joining portions of peripheral edge portions to each other by a method such as thermal welding. The lead-out portion 120 is joined to the inner bag 110 by overlapping the plurality of films constituting the inner bag 110 and joining other portions of the peripheral edge portions and the lead-out portion 120 by a method such as thermal welding.

In the present embodiment, the inner bag 110 is a so-called gusset type bag formed by a film of a first surface 111, a film of a second surface 112, and two films serving as gussets disposed at both end portions in the X-axis direction. The inner bag 110 is not limited to a gusset type and may be a so-called pillow type bag body formed of two films.

The films constituting the inner bag 110 are formed of a material having flexibility and a gas barrier property. Examples of the material of the films include polyethylene terephthalate (PET), nylon, and polyethylene. In addition, the films may be formed using a laminated structure in which a plurality of films formed of these materials is laminated.

In such a laminated structure, for example, the outer layer may be formed of PET or nylon excellent in impact resistance, and the inner layer may be formed of polyethylene excellent in ink resistance. Moreover, a film having a layer of aluminum or the like evaporated thereon or a thin film of aluminum may be used as one component of the laminated structure.

The inner bag 110 has the first surface 111 forming an upper surface and the second surface 112 forming a bottom surface. The first surface 111 and the second surface 112 face each other in the Z-axis direction. The first surface 111 and the second surface 112 form the largest main surfaces among the surfaces constituting the inner bag 110.

The inner bag 110 has a first end portion 113 and a second end portion 114. The first end portion 113 is an end portion on the +Y direction side. The second end portion 114 is an end portion on the -Y direction side. As the ink in the inner bag 110 is consumed, the first surface 111 and the second surface 112 are deformed so as to approach each other, whereby the volume of the inner bag 110 is reduced.

Here, in the liquid container 100, the Z-axis direction in which the first surface 111 and the second surface 112 of the inner bag 110 face each other is a thickness direction. In the liquid container 100, the Y-axis direction in which the first end portion 113 and the second end portion 114 of the inner bag 110 are provided at an interval is a length direction.

In the liquid container 100, the X-axis direction orthogonal to the thickness direction and the length direction is a width direction. In the present embodiment, the thickness direction is an up-down direction in a state where the liquid container 100 is mounted in the printing apparatus 10 in a normal use state.

The lead-out portion 120 is attached to the first end portion 113 of the inner bag 110. The lead-out portion 120 includes a supply path 123 in communication with the inside of the inner bag 110, a connection portion 128, and an engaged member 129.

The supply path 123 is a flow path for supplying the ink contained in the inner bag 110 to the printing apparatus 10. In a supply direction of the ink from the inner bag 110 toward the printing apparatus 10, an upstream end of the supply path 123 is located inside the inner bag 110, and a downstream end of the supply path 123 is located outside the inner bag 110.

The connection portion 128 is a portion that is connected by being attached to the first end portion 113 of the inner bag 110 by thermal welding. An upstream side of the supply path 123 is formed in the connection portion 128.

The engaged member 129 is connected to an end portion of the connection portion 128 on the +Y direction side. The engaged member 129 includes the liquid supply portion 121 having a tubular shape and engagement forming portions 122 located on both sides of the liquid supply portion 121 in the width direction of the liquid container 100.

The liquid supply portion 121 forms a downstream side of the supply path 123 and is connected to the liquid introduction portion 51 illustrated in FIG. 4. A leading end opening of the liquid supply portion 121 is sealed by a film FM in an initial state before being mounted in the printing apparatus 10.

Each engagement forming portion 122 has a plate-shaped portion and a positioning hole. The plate-shaped portions are disposed on both sides of the liquid supply portion 121 in the width direction of the inner bag 110. The two plate-shaped portions are engaged with the adapter 130.

Each positioning hole extends through the plate-shaped portion in the Z-axis direction. The two positioning holes position the adapter 130 with respect to the lead-out portion 120 when the adapter 130 is engaged with and attached to the lead-out portion 120.

The adapter 130 illustrated in FIG. 7 includes an adapter first surface 130fa and an adapter second surface 130fb. A recessed portion 131 that receives the liquid supply portion 121 of the lead-out portion 120 is formed in the adapter first surface 130fa. The recessed portion 131 is open in the +Y direction and the +Z direction. The adapter second surface 130fb is located on a side opposite to the adapter first surface 130fa.

The adapter 130 includes two positioning protrusions (not illustrated) and engagement claws (not illustrated) in the recessed portion 131. When the adapter 130 is attached to the lead-out portion 120 of the inner bag 110, the adapter 130 is oriented such that the adapter first surface 130fa faces the lead-out portion 120.

Next, the adapter 130 is moved relative to the lead-out portion 120 so as to approach the lead-out portion 120. In a movement process in which the adapter 130 approaches the lead-out portion 120, first, the two positioning protrusions are inserted into the two positioning holes of the engagement forming portions 122, and thus the position of the adapter 130 with respect to the lead-out portion 120 is defined.

Moreover, the engagement claws of the adapter 130 and the plate-shaped portions of the engagement forming portion 122 of the lead-out portion 120 are engaged with each other, and thus the adapter 130 is fixed to the lead-out portion 120. In the present embodiment, the adapter 130 is attached to the lead-out portion 120 of the inner bag 110, which is exposed from an exposure opening 213 of the outer bag 210 to be described later.

A circuit board 132 is attached to the adapter 130. The circuit board 132 is disposed in a recessed portion 89 which is formed in a corner portion where the adapter second surface 130fb and a front surface of the adapter 130 intersect.

On a front surface of the circuit board 132, a container terminal is disposed, and the container terminal comes into contact with the apparatus-side terminal 58 illustrated in FIG. 4 in a mounted state in which the liquid container 100 is mounted in the printing apparatus 10. On a back surface of the circuit board 132, a storage device that stores various types of information relating to the liquid container 100 is disposed.

The storage device is electrically connected to the container terminal by wiring. The various types of information stored in the storage device are, for example, information indicating the type of the liquid container 100, the amount of ink the liquid container 100 can contain, and the identification number. In the mounted state, the storage device and the control unit 20 of the printing apparatus 10 can exchange various types of information.

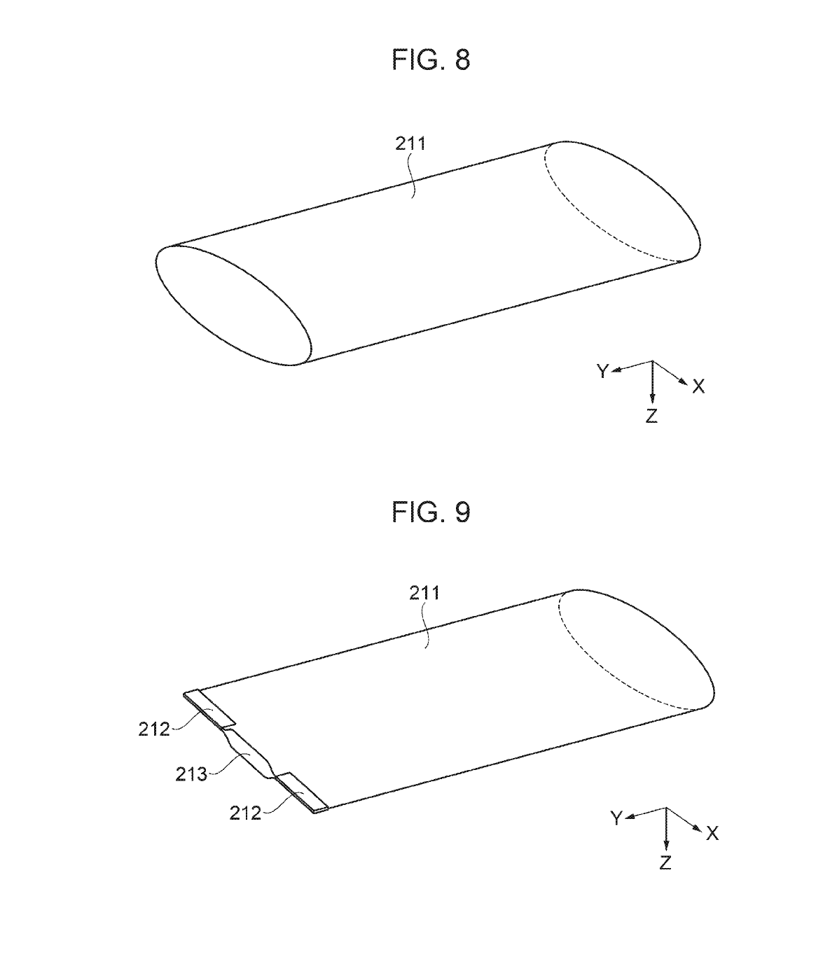

As illustrated in FIGS. 5 and 7, the outer bag 210 is a bag body that covers a periphery of the inner bag 110. The outer bag 210 has flexibility. The outer bag 210 is formed in a bag shape by sealing each of an opening in the +Y direction and an opening in the -Y direction of a film member 211 having a sleeve shape illustrated in FIG. 8 by a method such as thermal welding.

Therefore, as illustrated in FIG. 5, the short sides of the outer bag 210 in the present embodiment are formed by sealing the openings at both ends of the film member 211 by thermal welding. In the following description, the end of the film member 211 and the outer bag 210 in the +Y direction is referred to as a first end, and the end in the -Y direction is referred to as a second end.

In the present embodiment, the outer bag 210 made of the sleeve-shaped film member 211 does not have a joint portion formed by joining films to each other on the long sides. Therefore, it is possible to reduce entry of light such as ultraviolet rays into the outer bag 210 from an end surface of films constituting a joint portion.

The film member 211 is made of a resin material having a light-shielding property against ultraviolet rays. As a result, the outer bag 210 has a light-shielding property against ultraviolet rays. The film member 211 is produced, for example, by forming a resin material having a light-shielding property against ultraviolet rays into a sleeve shape by inflation molding or the like.

As the resin material having a light-shielding property against ultraviolet rays, for example, polyethylene, polypropylene, or the like mixed with a benzotriazole-based ultraviolet absorber, a triazine-based ultraviolet absorber, titanium oxide, zinc oxide, or the like can be adopted.

In this case, the outer bag 210 can have transparency that allows the inside of the outer bag 210 to be visually recognized. The film member 211 and the outer bag 210 of the present embodiment are made of, for example, polyethylene having a light-shielding property against ultraviolet rays and have a translucent orange color that allows the inside to be visually recognized.

As illustrated in FIGS. 5 and 9, a first end portion 212 that defines the short side of the outer bag 210 in the +Y direction is formed by sealing the opening of the film member 211 in the +Y direction. As illustrated in FIG. 9, the exposure opening 213 is provided at a center of the first end portion 212 in the X-axis direction. The exposure opening 213 is formed by sealing an opening at the first end of the film member 211 except for the center thereof.

As illustrated in FIG. 5, a second end portion 214 that defines the short side of the outer bag 210 in the -Y direction is formed by sealing the opening of the film member 211 in the -Y direction.

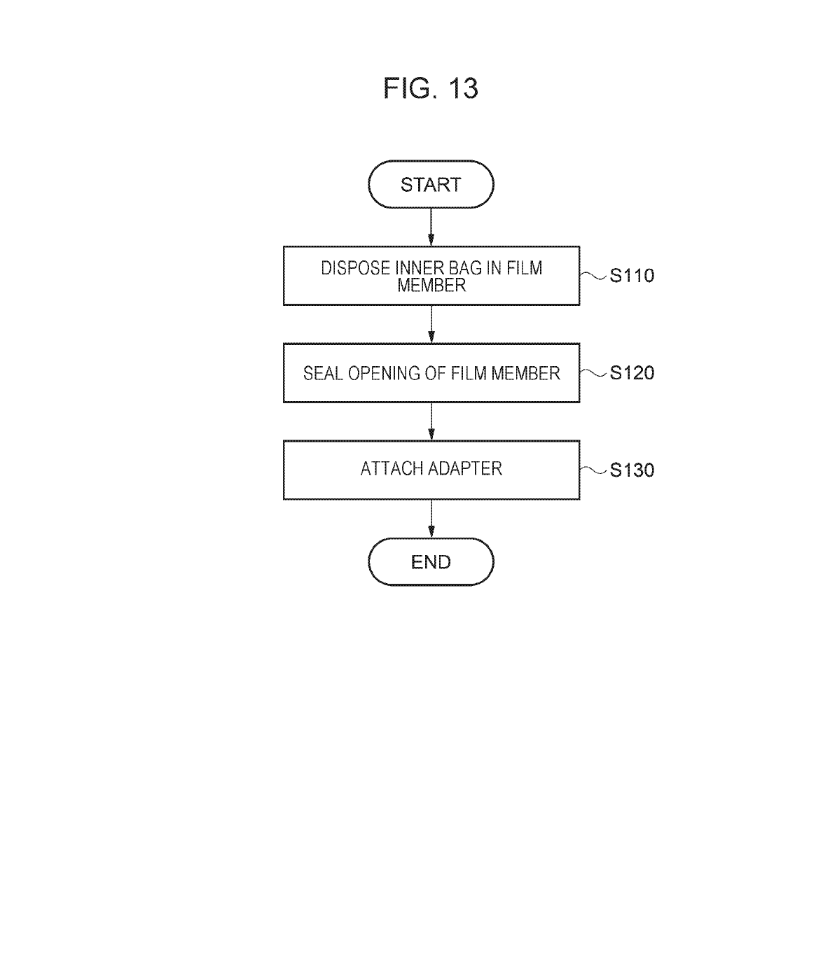

Next, an assembly procedure for manufacturing the liquid container 100 will be described with reference to a flowchart illustrated in FIG. 13. The assembly procedure for manufacturing the liquid container 100 corresponds to the method of manufacturing the liquid container 100.

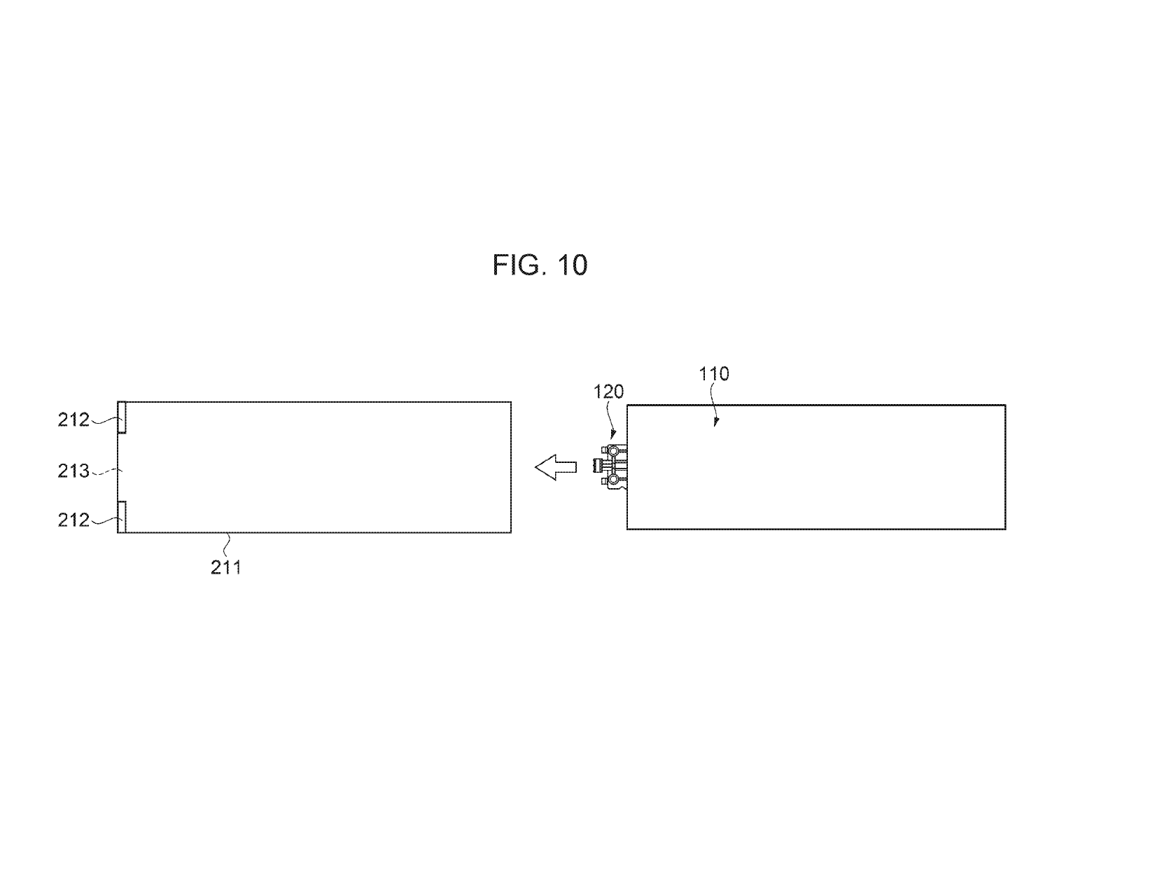

First, in step S110, the inner bag 110 is disposed in the film member 211. Specifically, as indicated by the arrow in FIG. 10, the inner bag 110 is inserted into the film member 211, in which the first end portion 212 illustrated in FIG. 9 is formed, from the opening of the second end of the film member 211 which is not sealed.

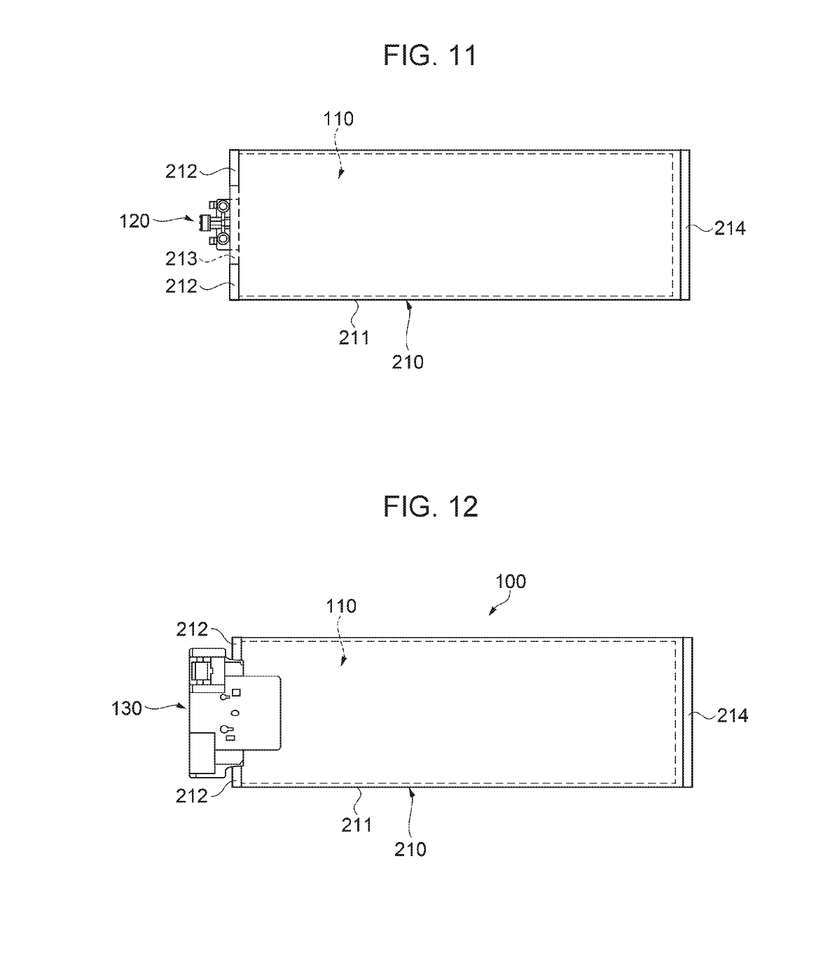

The inner bag 110 is inserted through the exposure opening 213 of the film member 211 to a position at which the lead-out portion 120 is exposed from the film member 211 (see FIG. 11). When the assembly in step S110 is completed, the assembly proceeds to step S120.

In step S120, the opening of the film member 211 is sealed. Specifically, as illustrated in FIG. 11, the opening at the second end of the film member 211 is sealed in a state where the inner bag 110 is inserted into the film member 211 to the position at which the lead-out portion 120 is exposed from the film member 211.

The opening at the second end of the film member 211 is sealed by thermal welding to form the second end portion 214, thereby forming the bag-shaped outer bag 210 that covers the periphery of the inner bag 110. The outer bag 210 covers the periphery of the inner bag 110 in a state where the lead-out portion 120 of the inner bag 110 is exposed.

In other words, the outer bag 210 covers the periphery of the inner bag 110 in a state where the ink in the inner bag 110 can be led out from the lead-out portion 120. When the assembly in step S120 is completed, the assembly proceeds to step S130.

In step S130, the adapter 130 is attached. Specifically, as illustrated in FIGS. 7 and 12, the adapter 130 is attached to the lead-out portion 120 of the inner bag 110 exposed from the outer bag 210. Thus, the liquid container 100 is completed. When the assembly in step S130 is completed, the assembly of the liquid container 100 is completed.

Filling of the inner bag 110 with the ink may be performed between step S120 and step S130, or may be performed after the assembly in step S130 is completed. Alternatively, the filling of the inner bag 110 with the ink may be performed before the assembly in step S110.

As described above, the liquid container 100 and the method of manufacturing the liquid container 100 according to the embodiment can provide the following effects.

The liquid container 100 includes the inner bag 110 capable of containing ink. The liquid container 100 includes the outer bag 210 covering the periphery of the inner bag 110 and having a light-shielding property against ultraviolet rays. The liquid container 100 includes the lead-out portion 120 capable of leading out the ink from the inner bag 110 covered with the outer bag 210.

According to this configuration, since it is not necessary to provide a configuration for preventing entry of ultraviolet rays at an end portion of the inner bag 110, it is easy to apply specifications similar to those of a bag body for containing a general ink to the inner bag 110. Therefore, it is possible to suppress entry of ultraviolet rays into the inner bag 110 and to suppress the process of manufacturing the liquid container 100 being complicated. Accordingly, automation of the process of manufacturing the liquid container 100 is facilitated, and it is possible to mass-produce the liquid container 100 at low cost.

The outer bag 210 is formed in a bag shape by sealing the openings at both ends of the film member 211 formed in a sleeve shape. According to this configuration, the outer bag 210 can be produced by a simple method.

The outer bag 210 has the short sides formed by sealing the openings at both ends of the film member 211 by thermal welding. According to this configuration, the outer bag 210 can be produced by a simple method.

The outer bag 210 has transparency that allows the inside of the outer bag 210 to be visually recognized. According to this configuration, the inner bag 110 can be visually recognized from the outside of the outer bag 210. Therefore, for example, since the specifications of the ink described on a label or the like attached to the inner bag 110 can be visually recognized from the outside of the outer bag 210, it is not necessary to newly attach, to the outer bag 210, a label or the like on which the specifications of the ink or the like are described.

The method of manufacturing the liquid container 100 includes disposing, in the film member 211 through the opening of the film member 211, the inner bag 110 including the lead-out portion 120 capable of leading out the ink, the film member 211 having a light-shielding property against ultraviolet rays and being formed in a sleeve shape. The method of manufacturing the liquid container 100 includes sealing the opening of the film member 211 to form the outer bag 210 in a state where the lead-out portion 120 is exposed from the film member 211.

According to this configuration, it is possible to suppress entry of ultraviolet rays into the inner bag 110 and to suppress the process of manufacturing the liquid container 100 being complicated. Therefore, automation of the process of manufacturing the liquid container 100 is facilitated, and it is possible to realize a method of manufacturing the liquid container 100 capable of mass-producing the liquid container 100 at a low cost.

The method of manufacturing the liquid container 100 further includes attaching the adapter 130 to the lead-out portion 120 exposed from the outer bag 210. According to this configuration, the liquid container 100 including the adapter 130 can be manufactured by a simple method.

The lead-out portion 120 is exposed from the film member 211 through the exposure opening 213 formed by sealing the opening at the first end of the film member 211 except for the center thereof. The outer bag 210 is formed by sealing the opening at the second end of the film member 211 in a state where the lead-out portion 120 is exposed from the film member 211 through the exposure opening 213.

According to this configuration, positioning of the inner bag 110 with respect to the outer bag 210 and manufacturing of the outer bag 210 covering the periphery of the inner bag 110 can be performed by a simple method.

The liquid container 100 according to the above-described embodiment of the present disclosure basically has the configuration described above, but it is of course possible to change or omit a partial configuration without departing from the gist of the present disclosure.

The method of manufacturing the liquid container 100 according to the above-described embodiment of the present disclosure basically has the configuration described above, but it is of course possible to change or omit a partial configuration without departing from the gist of the present disclosure.

The above-described embodiment and other embodiments described below can be implemented in combination with each other as long as there is no technical contradiction. Hereinafter, other embodiments will be described.

In the above-described embodiment, the film member 211 does not have to be formed in a sleeve shape by inflation molding or the like as long as the inner bag 110 can be disposed therein. For example, the film member 211 may be formed in a sleeve shape by joining films to each other. The joint portions formed by joining the films to each other are end portions in the X-axis direction that define the long sides of the outer bag 210.

In this case, the liquid container 100 may be accommodated in the case 61 in a state where the end portions of the outer bag 210 in the X-axis direction are folded back to the inner bottom surface side of the case 61. According to this configuration, it is possible to suppress entry of ultraviolet rays from end surfaces of the end portions defining the long sides of the outer bag 210.

In the above-described embodiment, the film member 211 and the outer bag 210 do not have to have transparency that allows the inside thereof to be visually recognized. In this case, the outer bag 210 may be provided with a label or the like on which the specifications of the ink or the like are described. Alternatively, the specifications of the ink or the like may be printed on the outer bag 210.

In the above-described embodiment, when the outer bag 210 is formed, the openings at both ends of the film member 211 do not have to be sealed by thermal welding. For example, the openings at both ends of the film member 211 may be sealed with an adhesive or an adhesive tape.

In the above-described embodiment, the liquid container 100 may be accommodated in the case 61 in a state where the second end portion 214 of the outer bag 210 is folded back to the inner bottom surface side of the case 61. According to this configuration, it is possible to suppress entry of ultraviolet rays from the end surface of the second end portion 214 of the outer bag 210.

In the above-described embodiment, the inner bag 110 does not have to be disposed in the film member 211 in a state where the first end portion 212 is formed in the film member 211. For example, the inner bag 110 may be disposed in the film member 211 by inserting the inner bag 110 into the film member 211, in which the second end portion 214 is formed, from the opening at the first end of the film member 211 which is not sealed. In this case, the opening at the first end of the film member 211 is sealed after the inner bag 110 is disposed in the film member 211.

Alternatively, the inner bag 110 may be disposed in the film member 211 by inserting the inner bag 110 into the film member 211, both ends of which are open, from either one of the openings at both ends of the film member 211. In this case, the openings at both ends of the film member 211 are sealed after the inner bag 110 is disposed in the film member 211.

In the above-described embodiment, the liquid container 100 does not have to include the adapter 130. In this case, the circuit board 132 may be attached to the lead-out portion 120 of the inner bag 110. In addition, the lead-out portion 120 may have a configuration similar to that of the guided portion included in the adapter 130. According to this configuration, when the liquid container 100 is accommodated in the case 61, the guided portion included in the lead-out portion 120 is guided by the guide portions 62 of the case 61, and thus the liquid container 100 is positioned with respect to the case 61.

What is claimed is:

1. A liquid container comprising:
an inner bag capable of containing a liquid;
an outer bag covering a periphery of the inner bag and having a light-shielding property against an ultraviolet ray; and
a lead-out portion capable of leading out the liquid from the inner bag covered with the outer bag.

2. The liquid container according to claim 1, wherein
the outer bag is formed in a bag shape by sealing openings at both ends of a film member formed in a sleeve shape.

3. The liquid container according to claim 2, wherein
the outer bag has short sides formed by sealing the openings at both ends of the film member by thermal welding.

4. The liquid container according to claim 1, wherein
the outer bag has transparency that allows an inside of the outer bag to be visually recognized.

5. A method of manufacturing a liquid container, comprising:
disposing, in a film member through an opening of the film member, an inner bag including a lead-out portion capable of leading out a liquid, the film member having a light-shielding property against an ultraviolet ray and being formed in a sleeve shape; and
sealing the opening of the film member to form an outer bag in a state where the lead-out portion is exposed from the film member.

6. The method of manufacturing a liquid container according to claim 5, further comprising:
attaching an adapter to the lead-out portion exposed from the outer bag.

7. The method of manufacturing a liquid container according to claim 5, wherein
the lead-out portion is exposed from the film member through an exposure opening formed by sealing an opening at a first end of the film member except for a center of the first end, and
the outer bag is formed by sealing an opening at a second end of the film member in a state where the lead-out portion is exposed from the film member through the exposure opening.
